(19) United States
(12) Patent Application Publication
(10) Pub. No.: US 2009/0121550 A1
(43) Pub. Date: May 14, 2009

(54) Universal Power Adapter

(76) Inventor: Louis Riviera, Perth Amboy, NJ (US)

Correspondence Address: Mr. Walter J. Tencza Jr., Suite 210, 100 Menlo Park, Edison, NJ, 08837, US

(21) Appl. No.: 11/938,317

(22) Filed: Nov. 12, 2007

(51) Int. Cl. H02J 7/00

(52) U.S. Cl. 307/66

(57) ABSTRACT

An apparatus is disclosed including a power source portion, and an electrical cord portion. The power source portion may include a protrusion, which can be inserted into a power tool portion in order for the protrusion to be electrically connected to the power tool portion, and a battery. The electrical cord portion may have a first end which is electrically connected to the power source portion and a second end which has an electrical plug which can be inserted into an electrical wall outlet. The apparatus may be configured so that the battery can operate a motor of the power tool portion in a direct current state and power from an AC electrical wall outlet can operate the motor of the power tool portion during an alternating current state.

### FIELD OF THE INVENTION

This invention relates to improved methods and apparatus concerning electric or power hand held tools.

### BACKGROUND OF THE INVENTION

Currently there are two main types of electric or power hand held tools. These two main types are distinguished by the type of power source that they need for operation. The first type of electric hand held tool is an AC (alternating current) power hand held tool that requires the tool to be plugged into an electric socket or electric wall receptacle directly or through an extension cord to acquire the electrical energy and/or power necessary for the operation of the electric hand held tool. The second type of electric or power hand held tool is a DC (direct current) power hand held tool that typically requires a battery or battery pack for the operation of the tool. Both AC and DC tools, offer a variety of tools such as drills, saws, hammers, flashlights, grinders, etc.

### SUMMARY OF THE INVENTION

In one or more embodiments of the present invention, an apparatus is provided comprising a power source portion, and an electrical cord portion. The power source portion may be comprised of a protrusion, which can be inserted into a power tool portion in order for the protrusion to be electrically connected to the power tool portion, and a battery. The electrical cord portion may have a first end which is electrically connected to the power source portion and a second end which has an electrical plug. The electrical plug may have at least two prongs for insertion into an electrical wall outlet.

The apparatus may be configured so that the battery can operate a motor of the power tool portion in a direct current state and the apparatus is configured so that the motor can be operated by alternating current power from an electrical wall outlet supplied through the electrical plug and through the electrical cord portion to the power tool portion during an alternating current state. The alternating current would first be converted to DC before activating the tool's motor.

The apparatus may include the power tool portion. The power tool portion may be a drill, a saw, or another type of tool. The power source portion may include a rectifier for changing AC power from an electrical wall outlet to DC power for powering the motor of the power tool portion. The power source portion may include power transistors to prevent the battery from being drained when not plugged into a power source. The power source portion may include a transformer, which receives alternating current from an electrical wall outlet to its first coil and induces the first voltage to an alternating current having a second lower voltage in the output coil. The apparatus may be configured to supply the alternating current having a second voltage to the power tool portion after being converted to DC.

One or more embodiments of the present invention may also include a method comprising, during a direct current state, supplying a power tool portion with direct current power from a battery from a power source portion so that a motor of the power tool portion is operated by the direct current power. The method may also include, during an alternating current state, supplying the power tool portion with alternating current power from an electrical wall outlet through the power source portion, so that the motor of the power tool portion is indirectly operated by the alternating current power. This design presently called a Universal Power Adapter (UPA) is intended for a variety of power hand tools that exist such as drills, saws, staplers, lights etc.

The UPA can be designed to accommodate what ever voltage any particular tool may need for operation.

### BRIEF DESCRIPTION OF THE DRAWINGS

FIG. 1 shows a side view of an apparatus in accordance with an embodiment of the present invention;

FIG. 2 shows a side view of another apparatus in accordance with another embodiment of the present invention;

FIG. 3 shows a side view of another apparatus in accordance with another embodiment of the present invention;

FIG. 4 shows a diagram of a circuit for use in one or more embodiments of the present invention;

FIG. 5 shows a side view of an apparatus for use in accordance with another embodiment of the present invention;

FIG. 6 shows a front view of an apparatus for use in accordance with another embodiment of the present invention;

FIG. 7 shows a side view of an apparatus for use in accordance with another embodiment of the present invention;

FIG. 8 shows a diagram of a circuit for use in one or more embodiments of the present invention;

FIG. 9 shows a diagram of a circuit for use in one or more embodiments of the present invention; and

FIG. 10 shows a device for inserting into a cigarette lighter port, or DC power port in accordance with an embodiment of the present invention.

### DETAILED DESCRIPTION OF THE DRAWINGS

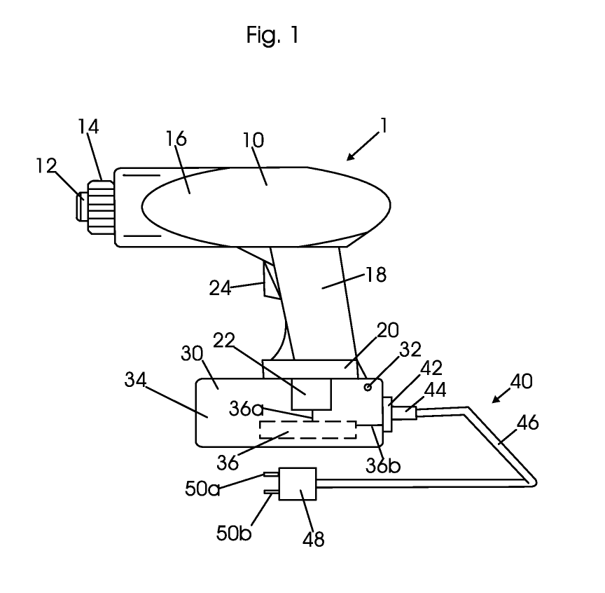

FIG. 1 shows a side view of an apparatus 1 in accordance with an embodiment of the present invention. The apparatus 1 includes a power hand held tool portion 10, a power source portion 30, and a cord device portion 40.

The power hand held tool portion 10 may be a device for drilling, or some other hand held power tool such as a saw, hammer, flashlight, grinder, etc. The power tool portion 10 may include a body section 16, a device 12, a device 14, a handle 18, a device 20, a device 22, and a push button device 24.

The power source portion 30 may include a charge indicator or charge LED (light emitting diode) 32, which turns a red color when the power tool portion 10 is charging but is not fully charged and turns a green color when the power tool portion 10 has fully charged.

The cord device portion 40 may include a device 42, a device 44, a cord (such as an electrical cord), an electrical plug 48, and prongs 50a and 50b.

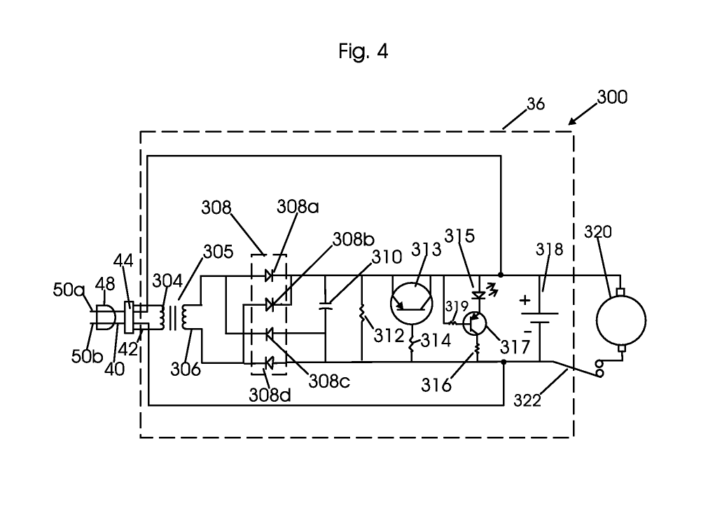

The power source portion 30 contains charging circuitry 36 within a housing 34. The power source portion 30 also includes a coupling and typically protruding device 22, which couples and electrically connects to the tool portion 10. The charging circuitry 36 may include components, such as shown in FIGS. 4, 8, and 9, to be described.

The device 22 may be electrically connected to the charging circuitry 36 by an electrical circuit connection 36a. The charging circuitry 36 may be electrically connected to the device 42 by electrical circuit connection 36b. The device 42 is electrically connected to the device 44, the cord 46, the electrical plug 48, and the prongs 50a, 50b, and 50c.

Typically when the prongs 50a and 50b are plugged into an AC electrical outlet, the power tool's battery also housed in portion 34 begins its charging cycle while the tool is simultaneously used.

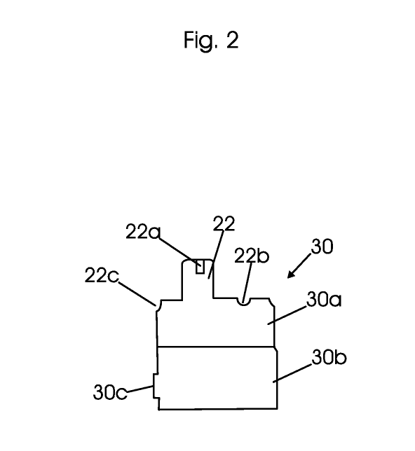

FIG. 2 shows a side view of part of the power source portion 30. The power source portion 30 may include the device 22 which protrudes out from the power source portion 30. The power source portion 30 includes charging circuitry 36, not shown in FIG. 2 but is diagramed in FIGS. 4, 8, and 9, within a housing 34. The power source portion 30 includes sections 30a and 30b and an AC receptacle 30c (openings not shown in FIG. 2). The device 22 includes an electrical contact or connector 22a for electrically connecting the power tool or power tool portion 10. The power source portion 30 also includes indentations 22b and 22c which help the tool portion 10 and the housing 34 of the power source portion 30 to have a stable fit in all three axes.

The top section 30a of the power source portion 30 may include a prior art battery pack used for power hand held tools known in the art. The bottom section 30b may be an added box used to fit additional components to allow the power source portion to be used in an AC (alternating current) manner (plugged into an electrical socket) and in a DC manner (with battery power). The section 30b may include an AC receptacle 30c into which one end of an AC electrical cord can be plugged in while the other end of the electrical cord is plugged into an AC electrical wall outlet.

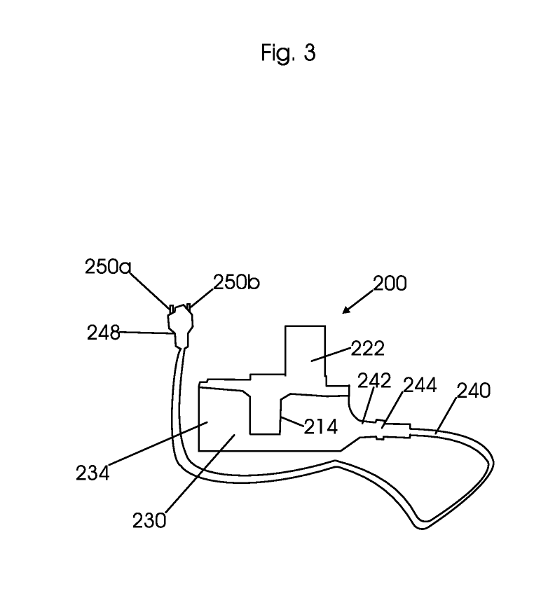

FIG. 3 shows a side view of an apparatus 200 in accordance with another embodiment of the present invention. The apparatus 200 includes a coupling device 222, a power source portion 230, a cord device 240, and a plug 248. The coupling device 222 may be similar to or identical to coupling device 22 shown in FIG. 2. The power source portion 230 may be similar to or identical to power source portion 30 shown in FIG. 1. The power source portion 230 may contain charging circuitry 36, such as described with reference to FIGS. 4, 8, and 9. The plug 248 and prongs 250a and 250b may be similar to or identical to the plug 48 and prongs 50a and 50b shown in FIG. 1. The housing 234 may be similar or identical to the housing 34 shown in FIG. 1.

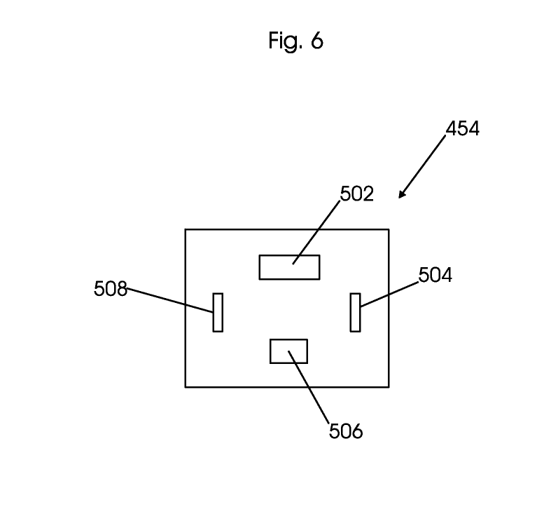

FIG. 4 shows a diagram of a circuit 300 for use in one or more embodiments of the present invention. The circuitry 300 includes charging circuitry 36, shown within dashed lines, which may be located in power source portion 30 shown in FIG. 1. FIG. 4 is the circuit that typically may exist for the universal power adapter, such as apparatus 1, in AC (alternating current) mode. The circuit 300 includes a device 48, an AC/DC socket 44, a transformer winding 304, a transformer winding 306, a full bridge rectifier 308, a capacitor 310, a resistor 312, transistor 313, a resistor 314, a light emitting diode 315, a resistor 316, a transistor 317, a resistor 319, a battery (or power supply) 318, a tool motor 320, and a trigger switch 322. The AC/DC socket 44 can be identical to AC/DC socket 454 shown in FIG. 6. The full bridge rectifier 308 can include diodes 308a, 308b, 308c, and 308d.

The transistor 313 prevents the battery 318 from being drained through the AC components, such as capacitor 310 and the resistor 312. The bridge rectifier 308 isolates the battery 318 from the transformer 305.

The transformer 305 is comprised of primary winding 304 and secondary winding 306. The transformer 305 may typically be an eight-amp twenty-volt output alternating current transformer. The plug 48 and prongs 50a and 50b are typically designed for a 120 volts alternating current electrical socket. The diodes 308a-d of the bridge rectifier 308 may each be six amp diodes. The capacitor 310 may be a 4700-microfarad capacitor. The resistor 312 may be a one-kilo ohm resistor. The transistor 313 may be a power transistor of the PNP, NPN, FET type, but not restricted to these types alone. The resistor 314 may be a ten-kilo ohm resistor. The LED 315 may be of the auto blinking type that blinks with a certain threshold current. The resistor 316 may be a one-kilo ohm resistor. The battery or battery pack 318 may be NiCD (nickel cadmium), NiMH (nickel metal-hydride) or any other type of appropriate battery, and can be upgraded as battery technology advances. The tool motor 320 is typically, inside the tool portion 10, and may typically be an eighteen-volt DC tool motor, but may typically run off a twelve volt DC battery as long as the battery supplies sufficient current or amperage.

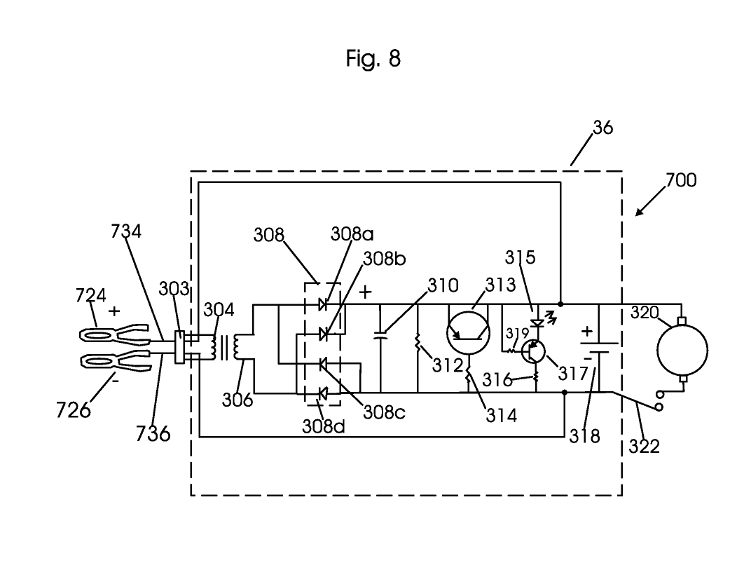

In operation the circuit 300 shown in FIG. 4 works as follows. When in AC power mode, the tool, such as hand held power tool portion 10 in FIG. 1 can be charged or utilized AC power via the AC power cord, such as cord 40 and plug 48 shown in FIG. 1, connected to the socket 303, shown in FIG. 8. I.e. plug 48 would be plugged into a source of AC power such as an electrical wall outlet. In AC power mode, electrical energy (typically 110 VAC) flows through the power cord 46 and into the primary winding 304 FIG. 4 of the transformer (which includes primary winding 304 and secondary winding 306 shown in FIG. 4).

The secondary winding 306 of the transformer supplies a lower voltage (i.e. lower than 110 VAC) to the full bridge rectifier 308. The rectifier 308 changes the AC to DC (direct current) pulses. The capacitor 310, which may be a 4700-microfarad capacitor, smoothes out the DC pulses to a reasonable level. The resistor 312 discharges the capacitor 310 when external AC power is disconnected from plug 48 shown in FIG. 4.

Transistor 313 switches on, when plug 48 is connected to an AC power source, causing the light emitting diode 315 to blink as a visual indicator that the power tool portion 10 or more specifically the tool's battery 318 attached to the power tool 10 in FIG. 1 is charging. Resistor 316 is in series with the light emitting diode 315 to limit the current that will pass through the light emitting diode within the tolerance of the LED 315 when power is being supplied to the circuit. When the trigger switch 322, which is activated by the tool trigger switch 24 of the tool portion 10 shown in FIG. 1, is depressed electrical energy activates the tool motor 320 shown in FIG. 4 into action. The action of the tool motor 320 shown in FIG. 4 is governed by the tool's design i.e. drilling, stapling, lighting, cutting etc. When the AC power is disconnected from the plug 48 the transistor 313 shuts down so that the battery 318 does not discharge through resistor 312. The transistor 317 is also shut down by transistor 313 thus restricting the blinking LED 315 from draining the battery or battery pack 318 of the power tool portion 10 of FIG. 1. The transistor 317 isolates the LED 315 and the resistor 316. The resistor 316 may be one-kilo ohms. The resistor 319 may be ten-kilo ohms.

FIG. 8 shows a circuit 700, which demonstrates a clamped power mode for the apparatus 1. In the clamped DC power mode a clamped power cord, including conductors 734 and 736 is used via the connector 303. In the circuit 700 of FIG. 8, the DC voltage is fed directly to the motor 320 when the switch 322 (via push button 24 of FIG. 1) is depressed and again the action of the tool portion 10 is activated by the tool's design i.e. drilling, lighting, cutting etc. At this time energy that is not being used to drive the motor 320 is going into charging the battery 318. When the tool's switch 322 (via push button 24 of FIG. 1) is not depressed the battery 318 receives most of the circuit energy for charging.

The FIG. 8 circuitry can be used in connecting a power tool such as power tool or portion 10 of FIG. 1, by clamps 724 and 726 to a car, boat, recreational vehicle, or any other available battery that will put out typically twelve volts DC and appropriate amperage, such as a quantity of amperage sufficient enough as to run the tool portion 10 with sufficient power which may be about three to six amps depending on the type of tool for tool portion 10. A circular saw tool i.e. will draw more amperage than a drill tool.

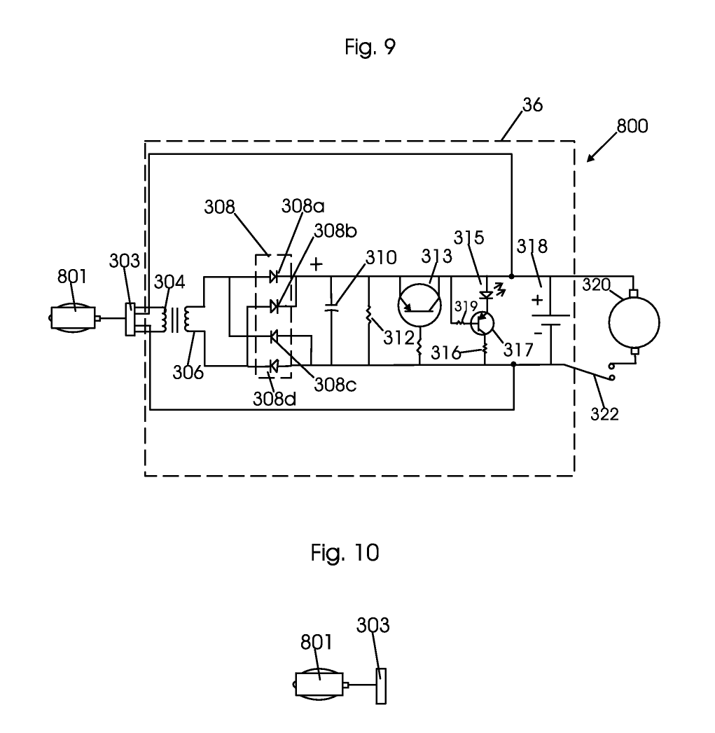

FIG. 9 shows a circuit 800, which demonstrates a second DC power mode (such as a cigarette light/power port power mode). This second DC power mode is activated when one end of a cigarette lighter plug adapter cord 801 is connected to connector 303 and the other end of the adapter cord 801 or an adapter cord plug or device adapter cord, not shown, is plugged into a cigarette lighter port, such as in an automobile. Again, as in FIG. 4, DC voltage is fed directly to the motor 320 when the switch 322 is depressed (via push button 24 shown in FIG. 1) and again the action of the tool is activated according to the tool's method operation i.e. drilling, lighting, cutting etc.

The circuitry of FIG. 9 can be used with a DC power port in vehicles, including a DC power port that was formerly known as a cigarette lighter. The device 801 can be electrically connected to a cigarette lighter DC port or any DC power port found in many cars, boats, recreational vehicles, etc.

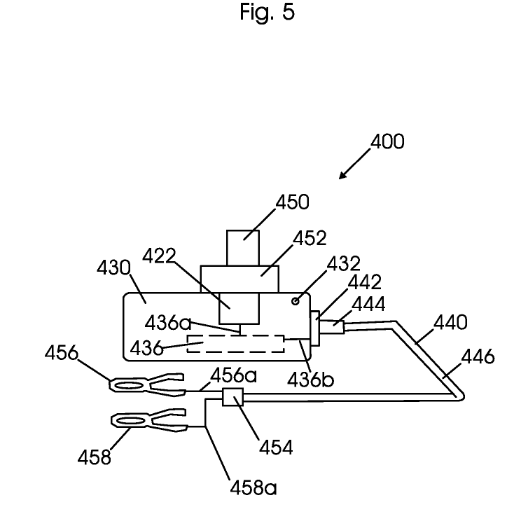

Note that in both DC modes of operation the DC power applied to the tool portion 10 “skips” over most of the circuit that is used in the AC mode of operation. This is accomplished automatically via the power cord 801 shown in FIG. 9, clamped cord including conductors 734 and 736 shown in FIG. 8 or the AC power cord 40 of FIG. 4. The AC cord, device 44 shown in FIG. 1 (and electrical prongs not shown of device 44) plugs into horizontal receptors 504 and 508 of the AC/DC socket 454 shown in FIG. 6. In both DC modes the procedure is the same but the cords are designed to use only the vertical receptors 502 and 506 in FIG. 6. For example component 444 of FIG. 5 would connect to the socket of FIG. 6 to receptors 502 and 506

FIG. 5 shows a side view of an apparatus 400 for use in accordance with another embodiment of the present invention. Apparatus 400 can be called a “Universal Power Adapter” (UPA). The apparatus 400 is configured for use in a car/boat battery DC power mode via battery clamps 456 and 458, a device (or electrical cord node) 454, and a cord 446.

The apparatus 400 includes a power source portion 430 and a cord device portion 440. The power source portion 430 may include a charge indicator or charge LED (light emitting diode) 432, which turns a red color when the power source portion 430 is attached to a power tool portion such as power tool portion 10, in FIG. 1, and the power tool portion 10 is charging but is not fully charged, and turns a green color when the power tool portion 10 has fully charged.

The power source portion 430 may also include a device 450, a device 452, a device 422, a conductor 436a, a battery 436, and a conductor 436b.

The cord device portion 440 includes a device 442, a device 444, a cord 446, an AC/DC socket 454 of FIG. 6, where “AC” is alternating current and “DC” is direct current, conductor 456a connected to a battery terminal clamp 456 and a conductor 458a connected to a battery terminal clamp 458.

The power source portion 430 contains a battery (or battery pack) within its housing. The device 450 connects to a battery 436, represented by dashed lines, within the housing 430. The device 450 may be electrically connected to the battery 436 by an electrical circuit connection 436a. The battery 436 may be electrically connected to the device 450 by electrical circuit connection 436b. The device 442 is electrically connected to the device 444, the cord 440, the electrical node 454, and the clamps 456 and 458.

FIG. 6 shows a front view of the AC/DC socket 454. The AC/DC socket 454 includes a DC receptor 502, an AC receptor 504, a DC receptor 506, and an AC receptor 508. The AC/DC socket 454 and similar or identical AC/DC socket 44 in FIG. 4, makes it simpler and safer for a consumer to switch from AC usage to DC. The AC/DC socket 454 does not require a switch (such as switch 322 in FIG. 4) but instead the socket 454 will accept three power cords, an AC power cord and two DC power cords. The AC/DC socket 454 keeps the electronics to a lower count and less complexity but also makes the change over from one type of power to the other substantially foolproof.

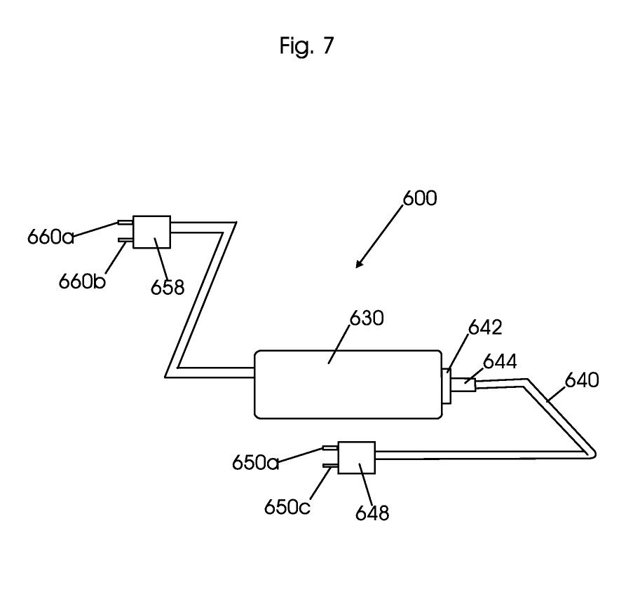

FIG. 7 shows a side view of an apparatus 600 for use in accordance with another embodiment of the present invention. The apparatus 600 includes a device 630, a device 642, a device 644, a cord 640, electrical plugs 648 and 658, and electrical prongs 650a-c, and 660a-b. In the FIG. 7 embodiment the electronics, such as the charging circuit from FIG. 4 are built into a box, such as 630. The device 630 may include a plastic box containing the circuit 36 of FIG. 4. also shown in FIG. 8. The circuit 36 may include components 304, 306, 308, 308a, 308b, 308c, 308d, 310, 312, 313, 314, 315, 316, 317, and 319 shown in FIGS. 4, 8, and 9 so that it leaves more room for the battery no. 318 in FIGS. 4, 8, and 9. In this embodiment the battery/battery pack, which is component 30 in FIG. 1 and in a different view component 200 in FIG. 3, would be in it's own housing, again, as shown in FIG. 1. The space needed from the battery pack would be a small area to contain socket 454 from FIG. 6. Socket 454 would serve as the connection point for the afore mentioned power cords 40 in FIG. 1, 48 in FIG. 4, 440 in FIG. 5, 658 in FIG. 7, 734 and 736 in FIG. 8, and 801 in FIG. 9.

It should be noted that the battery 318 shown in FIGS. 4, 8, and 9 is the tool's working battery. FIG. 1 shows a Universal Power Adapter, which may include power source portion 30, a cord device 40, and plug 4, inserted or electrically connected to the tool portion 10. In FIG. 1, apparatus 1 is shown as a complete unit. In this embodiment the battery 318 and the circuit 300 of FIG. 4 may be housed in the housing 34 of FIG. 1

Battery power has a shortcoming, which is that it can supply only a finite amount of power for a length of time. When the battery, such as battery 36 of FIG. 1 or 436 of FIG. 5 is drained by its usage the AC aspect of the apparatus 1 or apparatus 450 can be used so that the apparatus 1 or 450 is not useless. The Universal Power Adapter or apparatus 1 or 450 will still allow for a fresh battery change, but the true gain of the apparatus 1 or 450 will be evident when charging another battery would be highly inconvenient since charging a battery pack is often time consuming. With the apparatus 1 or 450 or other embodiments of the present invention this is not a concern since the power cord plug 48 and prongs 50a, and 50b can be plugged into an AC (alternating current) receptacle and work can continue.

In addition, while the apparatus 1 or 450 is in use the battery pack 30 of FIG. 1 or 430 of FIG. 5 is actually being charged. Lastly, the universal power adapter or apparatus 1 or 450 can also be “switched” to run the tool by connecting to a car or boat battery, using for example battery terminal clamps 456 and 458 to clamp and electrically connect to first and second terminals, respectively, of a car or boat battery. A “Universal Power Adapter” such as apparatus 400 shown in FIG. 5, or power cord adapter also known as a wall adapter apparatus 600 shown in FIG. 7 will also allow the power tool portion 10 of FIG. 1, to operate in a second DC power mode via a third power cord. The third power cord is terminated as a DC power plug component 801 in FIG. 9. This plug would plug into a power port somewhere in any vehicle and its opposite end shown, as component 44 in FIG. 1 would connect to the AC/DC socket component 303 in FIG. 8 but also shown discretely in FIG. 6

The clamped power cord made up of two conductors terminated by clamps as shown in FIG. 8. These clamps would connect to battery terminals located somewhere in any vehicle and it's opposite end shown as component 44 in FIG. 1 would connect to the AC/DC socket component 303 in FIG. 8 but also shown discretely in FIG. 6. The AC power cord terminated to a plug component 48 shown, as component 40 in FIG. 1 would plug into any standard AC outlet, which can be an extension cord or wall outlet. The AC cord's opposite end shown as component 44 in FIG. 1 would connect to the AC/DC socket component 303 in FIG. 8 but also shown discretely in FIG. 6

The circuit 700 shown in FIG. 8 permits the apparatus 1 to run off AC (alternating current) power or from a car or boat battery supplying electrical energy to motor 320 using the clamps 724 and 726, to clamp to first and second terminals, respectively, of a car or (but not limited to) boat battery. The LED set 315 can blink to provide a visual indication that the battery or battery pack, such battery 318 in the circuit 36 in FIG. 8, is being charged.

Note that although the tool motor 320 is rated at an eighteen volts direct current (DC), the tool motor 318 will run off a twelve volts direct current battery as long as the battery supplies sufficient amperage.

The apparatus 200 in FIG. 3 can be designed into new products. The apparatus 200 in FIG. 3 could also be sold as an aftermarket device to bring tools already in use a longer life. The charging circuit, such as circuit 36 in FIG. 4, including components 304, 306, 308, 308a, 308b, 308c, 308d, 310, 312, 313, 314, 315, 316, 317, and 319 could be designed into the tool body, such as into the body of hand held power tool portion 10 of FIG. 1, keeping the charging circuit, not including battery 318, separate from the battery pack, such as battery 318 in FIG. 4.

In one embodiment, the charger or apparatus 200 shown in FIG. 3 could also be designed in a “piggy back” fashion in which they slide or snap together in a variety of ways to accomplish less waste by discarding the battery pack, such as battery 318 only while continuing to use the charging circuitry, such as the circuitry 36, not including battery 318.

In accordance with alternative embodiments of the present invention, the Universal Power Adapter could within scope of the invention be made in its simplest form, which would be to have an AC adapter so as to be able to continue using the tool by connecting the adapter to the tool in place of its original battery/battery pack.

Although the invention has been described by reference to particular illustrative embodiments thereof, many changes and modifications of the invention, including those possible variations of the electric circuit, may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a power source portion;
an electrical cord portion;
wherein the power source portion is comprised of
a protrusion which can be inserted into a power tool portion in order for the protrusion to be electrically connected to the power tool portion;
a battery;
wherein the electrical cord portion has a first end which is electrically connected to the power source portion and a second end which has an electrical plug;
wherein the electrical plug has at least two prongs for insertion into an electrical wall outlet;
and wherein the apparatus is configured so that the battery can operate a motor of the power tool portion in a direct current state and the apparatus is configured so that the motor can be operated by alternating current power from an electrical wall outlet supplied through the electrical plug and through the electrical cord portion to the power tool portion during an alternating current state.

2. The apparatus of claim 1 wherein
the apparatus includes the power tool portion.

3. The apparatus of claim 2 wherein
the power tool portion is a drill.

3. The apparatus of claim 2 wherein
the power tool portion is a saw.

4. The apparatus of claim 1 wherein
the power source portion includes a rectifier for changing AC power from an electrical wall outlet to DC power for powering the motor of the power tool portion.

5. The apparatus of claim 1 wherein
the power source portion includes a transistor which prevents the battery from being drained during the alternating current state.

6. The apparatus of claim 1 wherein
the power source includes a transformer which receives alternating current having a first voltage from an electrical wall outlet and lowers the first voltage to an alternating current having a second voltage;
and wherein the apparatus is configured to supply the converted alternating current having a second voltage to the power tool portion.

7. A method comprising:
during a direct current state supplying a power tool portion with direct current power from a battery from a power source portion so that a motor of the power tool portion is operated by the direct current power;
during an alternating current state supplying the power tool portion with alternating current power from an electrical wall outlet through the power source portion, so that the motor of the power tool portion is operated by the converted alternating current power.

8. The method of claim 7 wherein
the power tool portion is a drill.

9. The method of claim 8 wherein
the power tool portion is a saw.

10. The method of claim 7 wherein
the power source portion includes a rectifier for changing AC power from an electrical wall outlet to DC power for powering the motor of the power tool portion during an alternating current state.

11. The method of claim 7 wherein
the power source portion includes a transistor which prevents the battery from being drained during the rest (non-charging) state.

12. The method of claim 7 wherein
the power source portion includes a transformer which receives alternating current having a first voltage from an electrical wall outlet and lowers the first voltage to an alternating current having a second voltage;
and wherein the apparatus is configured to supply the alternating current having a second voltage through the electronic circuit to the power tool portion.
